(19) United States
(12) Patent Application Publication
(10) Pub. No.: US 2017/0019508 A1
(43) Pub. Date: Jan. 19, 2017

(54) PHYSICAL OBJECT DROP AND IMPACT ALARM DEVICE

(71) Applicant: John Michael Melack, Dixon, CA (US)

(72) Inventor: John Michael Melack, Dixon, CA (US)

(21) Appl. No.: 14/803,071

(22) Filed: Jul. 18, 2015

(51) Int. Cl. H04M 1/02; G08B 21/18

(52) U.S. Cl. CPC H04M 1/0202; G08B 21/18

(57) ABSTRACT

The present invention comprises a device which emits an audible sound when it is dropped and impacts upon the ground or other surface. The device is small enough to be easily placed in a user's wallet, on a keychain, or other valuable and will alert the user when these valuables are dropped. The device is comprised of a low power MEMS accelerometer and a low power microcontroller so that the device will stay powered “on” for an extended amount of time, even while using thin, low energy batteries such as coin cells. The audible sound emitting functionality is comprised of a small, low-power piezoelectric buzzer. In normal operating conditions the device will stay “on” and provide maintenance and worry-free operation for many years.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present invention is in the technical field of consumer electronics. More specifically, the present invention is in the technical field of hand-held electro-mechanical devices used, worn, and/or carried daily, such as cell phones.

### SUMMARY

The present invention is a device which emits an audible sound when dropped. The device is small enough to be easily carried in a user's wallet, on a key chain, etc. so that if these valuables are accidentally dropped the user is alerted. The device uses low-power electronics and will stay powered “on” for many years providing maintenance and worry-free normal operation.

### DESCRIPTION OF THE DRAWINGS

FIG. 1A is a side view of a credit card shaped embodiment of the invention;

FIG. 1B is a top view of a credit card shaped embodiment of the invention;

FIG. 1C is a perspective view of a credit card shaped embodiment of the of the invention;

FIG. 1D is a perspective cutaway drawing view of a credit card shaped embodiment of the of the invention;

FIG. 2 is a perspective view of a key chain hole in another embodiment of the invention;

### DETAILED DESCRIPTION

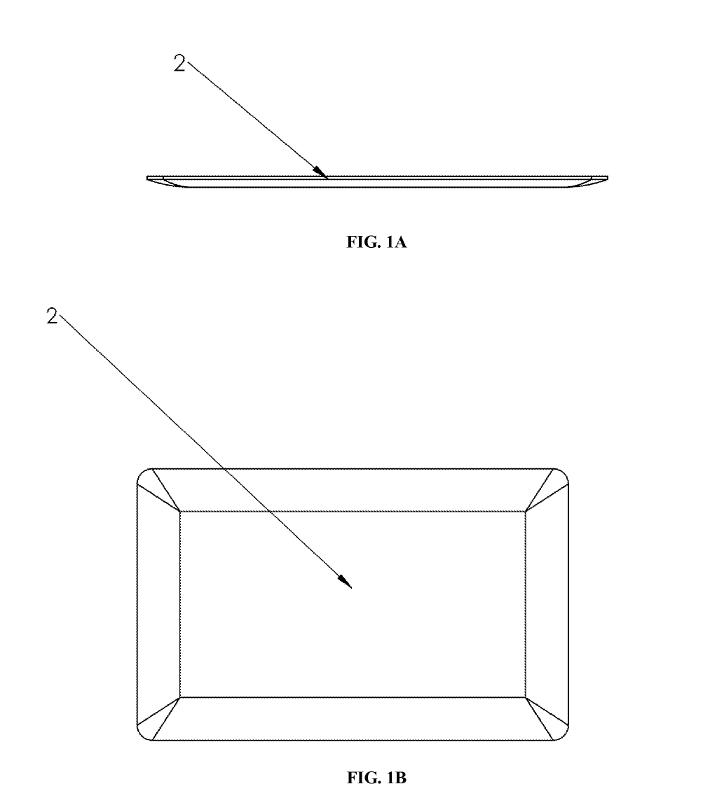

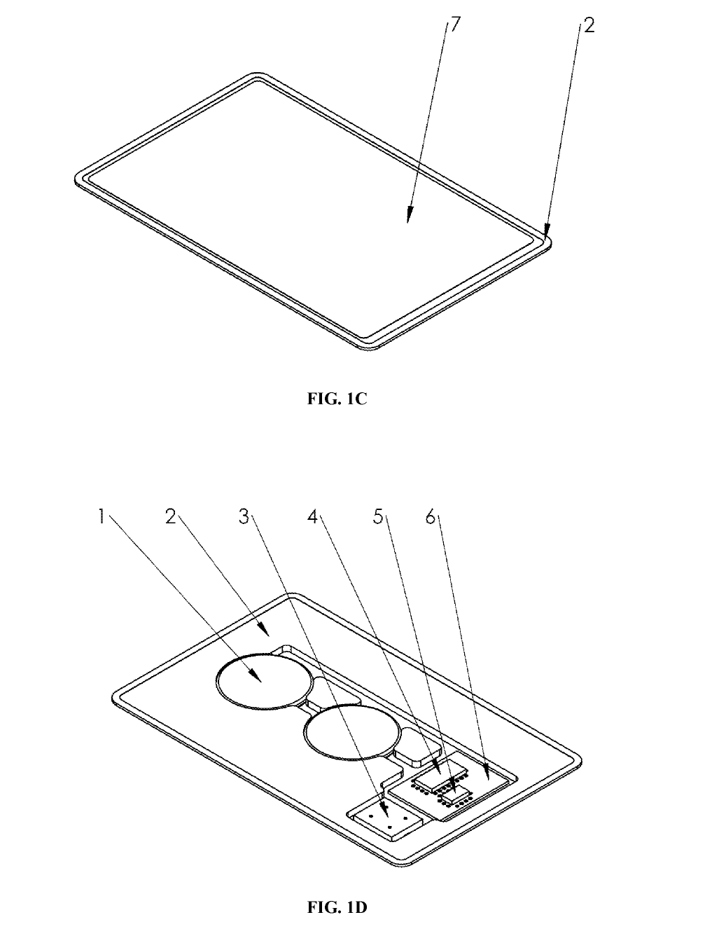

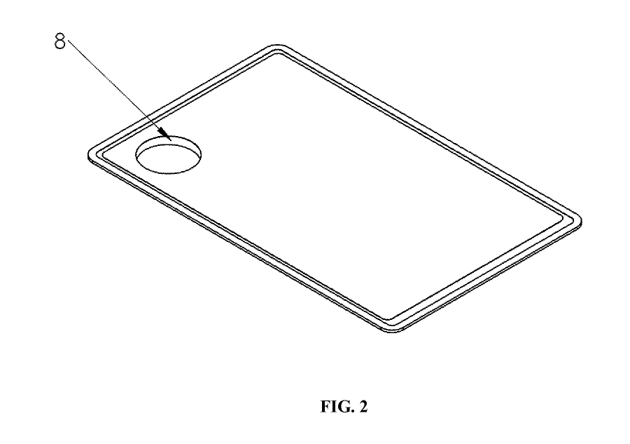

One possible embodiment of the invention, as shown in FIG. 1A, is comprised of a rigid structural housing 2 which supports and contains electrical components. The rigid structural housing 2 also provides a shape that the user can hold.

The top view shown in FIG. 1B shows the front face of the rigid structural housing 2. In one possible embodiment of the invention, the rigid structure housing 2 is shaped like a credit card, so it may easily fit in the user's wallet. The edges are curved to allow easy insertion into the user's wallet. The rigid structural housing 2 may be comprised of plastic, metal, or other materials. The shape of the device is such that it may be easily manufactured at high quantities using processes such as injection molding, compression molding, or with other high volume production equipment.

The bottom perspective view in FIG. 1C shows the cover 7 which encloses the electronics in the rigid structural housing 2. The cover 7 may be mechanically bonded to the rigid structural housing 2 with glue, ultrasonic bonding, or other processes.

FIG. 1D shows the internal components comprised of a piezoelectric buzzer 3, microcontroller 4, accelerometer 5, circuit board 6, and a coin cell battery 1. Electrical wiring may be used to connect the components. The device may include multiple coin cell batteries or other types of energy storage devices to power the device. The invention may also include multiple piezoelectric buzzers or use other types of sound producing devices.

As the accelerometer 5 detects the specific motion of a dropped object, it communicates with the microcontroller 4, which is programmed to interpret the motion and to send a signal to the piezoelectric buzzer 3 to produce an audible sound. The specific motion of a dropped object is comprised of a freefall, an abrupt acceleration change, and a resting state. When the system is not experiencing the physical acceleration specifics of a drop, the electronics will reside in a low power state and conserve energy.

In another embodiment of the invention shown in FIG. 2, the device 8 is comprised of a key chain hole 9 to enable the device to be easily connected to the user's key chain. In such an embodiment, the device could take on other non-credit card forms, such as a bottle opener or other possible key chain ornament shapes.

In broad embodiment, the invention is a device which may be connected to or stored in a user's valuables and emits an audible sound when dropped.

The advantages of the present invention include, without limitation, drop and loss detection of one's valuables over an extended period of time. The device uses, without limitation, an ultra-low power MEMS accelerometer, which will allow the device to remain powered “on” for many years because it draws very little power. The long period of powered “on” usage with no maintenance and worry-free operation comprises an advantage of the present invention. Once the batteries have reached a critical low level, the device may alert the user, in the form of an audible beep, or other means, that the battery and/or unit need to be replaced. The device may also include an internal rechargeable battery and may include piezoelectric components or other means to charge the internal battery. The device may also include features, such as a removable battery slot, so that the user could replace the battery.

In another embodiment of the invention, a cellular phone app could be programmed so that a user's cellular phone emits an audible sound or vibration when dropped.

The invention is not limited by the above described embodiments and examples, but includes all embodiments within the scope and spirit of the invention.

1. An electronic device comprising:
a) a structural enclosure to hold electronics, and
b) an accelerometer, and
c) an audio source, and
d) a power source, and
e) a microcontroller
whereby said microcontroller is connected to said accelerometer, power source, and audio source and said microcontroller is programmed to detect a condition in which said electronic device falls and impacts a surface and to command sound production from said audio source.

2. The electronic device of claim 1 wherein the accelerometer is a low power MEMS accelerometer.

3. The electronic device of claim 1 wherein the power source is a lithium ion battery.

4. The electronic device of claim 1 wherein the audio source is a piezoelectric buzzer.

5. The electronic device of claim 1 wherein the physical enclosure is shaped like credit card and fits in a wallet.

6. The electronic device of claim 1 wherein the physical enclosure may be attached to a key chain.

7. The electronic device of claim 1 wherein the device is a cellular phone.
